(19) United States
(12) Patent Application Publication
(10) Pub. No.: US 2012/0244384 A1
(43) Pub. Date: Sep. 27, 2012

(54) Stress Corrosion Resistant Aluminum Beverage End Closure

(75) Inventor: Ronald P. Burt, Golden, CO (US)

(73) Assignee: BALL CORPORATION, Broomfield, CO (US)

(21) Appl. No.: 13/053,881

(22) Filed: Mar. 22, 2011

(51) Int. Cl. B32B 15/01

(52) U.S. Cl. 428/654

(57) ABSTRACT

This invention provides an aluminum end closure for interconnection to a container, wherein the end closure comprises an aluminum alloy substrate and a cladding layer on the exterior of the substrate that is not susceptible to stress corrosion

### FIELD OF THE INVENTION

This invention relates to an aluminum beverage end closure for interconnection to a container, wherein the end closure comprises an aluminum alloy substrate and a cladding layer on the exterior of the substrate that is not susceptible to stress corrosion.

### BACKGROUND OF THE INVENTION

Containers, and more specifically metallic beverage containers, are typically manufactured by interconnecting a beverage can end closure on a beverage container body. In some applications, an end closure may be interconnected on both a top side and a bottom side of a can body. More frequently, however, a beverage can end closure is interconnected on a top end of a beverage can body which is drawn and ironed from a flat sheet of blank material such as aluminum. Due to the potentially high internal pressures generated by carbonated beverages, both the beverage can body and the beverage can end closure are typically required to sustain internal pressures exceeding 90 psi without catastrophic and permanent deformation. Further, depending on various environmental conditions such as heat, over fill, high CO2 content, and vibration, the internal pressure in a typical beverage can may at times exceed 100 psi. Thus, beverage can bodies and end closures must be durable to withstand high internal pressures, yet manufactured with extremely thin and durable materials such as aluminum to decrease the overall cost of the manufacturing process and the weight of the finished product.

Aluminum beverage end closures have typically been produced from aluminum alloy (AA) 5182 sheet because the alloy provides both high strength and good formability. However, since the magnesium content in AA5182 is greater than about 4%, the material is susceptible to stress-corrosion cracking.

For stress-corrosion failures to occur, three conditions must be present: a susceptible material, a sustained tensile stress, and a corrodant. When an aluminum beverage end closure is seamed onto a filled container, the internal container pressure of the container produces a tensile stress across the score formed on the exterior surface of the end closure (the score panel). If a corrodant (for example, water) becomes present on the end closure, all three conditions for stress-corrosion failures are present and stress-corrosion cracking can initiate along the score of the end closure. As the stress-corrosion cracks propagate through the thickness of the metal beneath the score, a point is reached where the cross-sectional area can no longer sustain the internal pressure and the score panel bursts outward, resulting in the ultimate failure of the end closure. These failures are disruptive to the distribution of filled containers and expensive to container manufacturers and distributors.

U.S. Patent Application Publication No. 2010/0028715 to Kilmer et al., incorporated herein by reference in entirety discloses a casting of a multilayer metal ingot with a divider metal, wherein the molten metal's may be the same or different metals, preferably aluminum alloys of the AA series 1000, 2000, 3000, 4000, 5000, 6000, 7000, or 8000. The divider metal may be an aluminum alloy and preferably contains at least 97% aluminum and has a high solidus temperature such as AA1000 series alloy.

WO2008/155067A1 to Wittebrood, incorporated herein by reference in entirety discloses an aluminum alloy brazing sheet product comprising a thin covering material layer, a core material layer, and an aluminum alloy brazing material layer interposed between the thin covering material and the core material. The thin covering material layer is a free aluminum alloy having a composition within the range of AA1000 series aluminum alloys, and preferably an aluminum alloy selected from the group comprising AA1050, AA1070, AA1100, AA1145 and AA1230.

U.S. Patent Application Publication No. 2009/0130481 to Takada et al., incorporated herein by reference in entirety discloses a clad material composed of a core material and one or more skin materials which are superimposed on either one face of the core material or both faces of the core material.

U.S. Pat. No. 6,030,710 to Nitowski et al., incorporated herein by reference in entirety discloses the use of AA5000 series in particular, the AA5182 alloys as suitable for the container bodies or container end panels.

Thus, there is a need to provide a container end closure with an exterior surface that reduces the susceptibility of stress corrosion cracking

### SUMMARY OF THE INVENTION

The present invention provides an aluminum beverage end closure that is produced from an aluminum alloy cladding layer on the exterior surface of an aluminum alloy substrate that reduces the susceptibility to stress corrosion on the exterior surface of the end closure. The substrate material for the end closure may be any suitable material known in the art. In some embodiments, the substrate layer may be made of a 5000 series aluminum alloy, including but not limited to AA5182. In other embodiments, the magnesium content of the substrate material is greater than about 4 percent.

The cladding material for the cladding layer may be any suitable material that is resistant to stress corrosion that is known in the art. In some embodiments, the cladding layer is a 5000 series or 1000 series aluminum alloy. In particular, aluminum alloys with less than about 4% magnesium are preferred for the cladding layer because they offer good strength and formability while reducing the susceptibility to stress corrosion. In some embodiments, the cladding layer may be AA5042. In other embodiments, the cladding layer may be AA1100.

### BRIEF DESCRIPTION OF THE DRAWINGS

FIG. 1 illustrates a single cladding layer on a substrate; and

FIG. 2 illustrates an alternative embodiment of the present invention which utilizes multiple cladding layers on a substrate; and

FIG. 3 illustrates an alternative embodiment of the present invention which utilizes a double seaming end closure.

### DETAILED DESCRIPTION OF THE INVENTION

For purposes of illustration, the following reference numbers and components are printed in the drawings:

| No. | Component |
|---|---|
| 100, 200 | Beverage End Closure |
| 104 | Cladding Layer |
| 108, 208 | Substrate Layer |
| 110, 210 | Score |
| 204 | First Cladding Layer |
| 214 | Second Cladding Layer |
| 300 | End Closure Edge |
| 304 | Peripheral Cover Hook |
| 308 | Chuck Wall |
| 312 | Central Panel |
| 316 | Countersink |
| 320 | Inner Panel Wall |
| 324 | Outer Panel Wall |

The present invention provides a novel aluminum clad beverage end closure. This aluminum end closure generally comprises a substrate material and a cladding material. Though the substrate may be any suitable material known in the art, in some embodiments the aluminum alloy substrate material is a 5000 series aluminum alloy. In some embodiments, the aluminum alloy substrate contains greater than about 4% magnesium. In still other embodiments, the substrate material is aluminum alloy 5182. The substrate material provides strength to the end closure, which is necessary to prevent buckling, rupture and ultimate failure as a result of the internal pressures of approximately 100 psi, which may be present in a carbonated drink container.

The substrate material is protected on its exterior surface by a cladding layer and can be any material that is resistant to stress corrosion as known in the art. This cladding layer can be any aluminum alloy, but is preferably a 1000 or 5000 series aluminum alloy. In an embodiment, the cladding layer is aluminum alloy 5042. In other embodiments the cladding material may be 1100 aluminum alloy. In still other embodiments, the cladding layer is an aluminum alloy with less than about 4% magnesium. As will become readily apparent, many different combinations of the cladding material and the substrate material are contemplated and suitable for this design.

The thickness of the cladding material is dependent upon the core material and the alloy material. The thickness of this cladding layer can range from about 5% to about 20% of the total thickness of the sheet with a tolerance of about 2%. The thickness is measured optically on a polished cross-section of the sheet and is generally uniform across the sheet prior to the scoring operation. Following the scoring operation, it is expected that the thickness of the cladding layer will be thinner along the walls than at the bottom of the score, which should remain about the same percent of the total thickness as the initial thickness after applying the cladding layer.

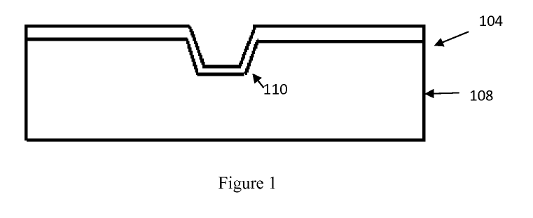

With reference to FIG. 1, the beverage end closure 100 is shown containing a substrate layer 108 and a cladding layer 104. A score 110 is also shown on a beverage end closure 100. The score 110 has a continuous unbroken cladding layer 104. The cladding layer 104 is applied to the substrate layer 108 in a uniform manner, though the thickness near the score following the scoring process may vary.

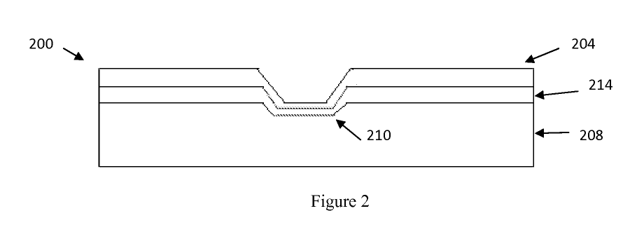

FIG. 2 illustrates a second embodiment of the present invention. The beverage end closure 200 contains a substrate layer 208 and first and second cladding layers 204 and 214, respectively. Though only two layers of the cladding material is shown, it should be understood that additional layers could be used. The thickness of the first and second cladding layers 204 and 214, respectively, may be equivalent or they may vary from each other depending on the application. Furthermore, the material of the first cladding layer 204 and the material of the second cladding layer 214 may be the same or they may be different. The first cladding layer 204 and the second cladding layer 214 are preferably either aluminum alloy wherein the magnesium content is less than about 4%, including but not limited to 1000 series or 5000 series or combinations thereof.

During the manufacturing of metal containers used in the beverage and food industry, certain coatings are often applied to internal and external surfaces of the containers. In embodiments of the invention, epoxy, phenolic or other polymer based or non-polymer based coatings, organic or inorganic chemical coatings may be applied to the interior and/or exterior of the end closure. These coatings may be hard, flexible, corrosion resistant, water impermeable, tolerant to pHs varying from about 0-14, water transmission, halide penetration—in particular chloride, oxygen permeability and solvent resistant which are desired for sanitary can coatings. The coatings may be applied to prevent cans from staining during retorting and/or other processes, as well as to prevent corrosion and “scalping”, which may alteration of the taste of a beverage or food stored in a container resulting from the beverage or food contacting the interior surface of the container. The coatings may be applied before shaping, closing or mechanical joining processes and/or after. Specialized coatings such as brand names may also be applied. Coatings applied to the exterior of surface the process do no significantly affect line processing speeds.

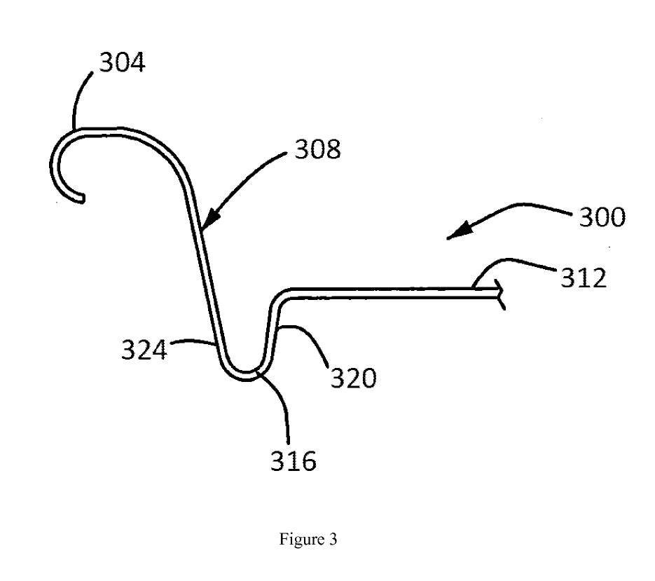

FIG. 3 depicts a beverage container end closure shell shown before a double seaming process is performed to join the container body (not shown) to the end closure. More specifically, the end closure 300 is generally comprised of a peripheral cover hook 304, a chuck wall 308 which extends from the peripheral cover hook 304 and which is interconnected to a countersink 316 on a lower end. The countersink 316 is generally comprised of an inner panel wall 320 and an outer panel wall 324, and wherein the inner panel wall 320 is interconnected to the central panel 312. U.S. Pat. No. 7,743,635 to Reed et al. illustrates examples of the container end, and is incorporated herein in their entirety by reference.

It should be understood that though the term “beverage end closure” is used throughout the description, the instant invention could also be used for pressurized metal containers, including aerosol, food, wax bin, heating, retorting and beverage containers.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A metallic material adapted for use as at least one of a beverage container and a beverage end closure, comprising:
a substrate layer; and
at least one cladding layer, wherein the cladding layer comprises a material containing less than about 4% magnesium.

2. The metallic material of claim 1, wherein the cladding layer is aluminum alloy 5042.

3. The metallic material of claim 1, wherein the substrate layer is aluminum alloy 5182.

4. The metallic material of claim 1, wherein the at least one cladding layer is selected from the group consisting of an aluminum alloy 1000 series, an aluminum alloy 5000 series and combinations thereof.

5. The metallic material of claim 1, wherein the cladding layer is aluminum alloy 1100.

6. The metallic material of claim 1, wherein the end closure further comprises a score.

7. The metallic material of claim 6, wherein a thickness of the cladding layer on a bottom of the score is approximately equal to an initial thickness of the cladding layer measured as a percent of the metallic material thickness.

8. The metallic material of claim 1, wherein a thickness of the cladding layer is about 5% to about 20% of a total thickness of the substrate layer and the cladding layer.

9. The metallic material of claim 1, further comprising a coating.

10. The metallic material of claim 1, wherein the coating comprises a phenolic material.

11. A metallic end closure with an improved material adapted for interconnection to a container, the end closure including a peripheral curl, a chuck wall interconnected to said peripheral curl and extending downward at a predetermined angle, a countersink outer panel wall interconnected to a lower end of the chuck wall, a central panel interconnected to an inner panel wall of the countersink, the improvement comprising:
a substrate layer, wherein the substrate layer is a 5000 series aluminum alloy; and
a cladding layer, wherein the cladding layer comprises a material containing less than about 4% magnesium.

12. The metal end closure of claim 11, wherein the cladding layer is aluminum alloy 5042.

13. The metal end closure of claim 11, wherein the substrate layer is aluminum alloy 5182.

14. The metal end closure of claim 11, wherein the cladding layer is aluminum alloy 1100.

15. The metallic end closure of claim 11, wherein the end closure further comprises a score, which defines an area with reduced thickness to facilitate opening.

16. The metallic end closure of claim 15, wherein a thickness of the cladding layer on a bottom of the score is approximately equal to an initial thickness of the cladding layer measured as a percent of the metal end closure thickness.

17. The metallic material of claim 11, wherein a thickness of the cladding layer is about 5% to about 20% of a total thickness of the substrate layer and the cladding layer.

18. The metallic material of claim 11, further comprising a coating.

19. The metallic material of claim 11, wherein the coating comprises a phenolic material.
